(19) United States
(12) Patent Application Publication
(10) Pub. No.: US 2025/0347774 A1
(43) Pub. Date: Nov. 13, 2025

(54) METHOD FOR ASCERTAINING AN OCCLUSION OF A RADAR SENSOR AND OCCLUSION ASCERTAINMENT DEVICE

(71) Applicant: Robert Bosch GmbH, Stuttgart (DE)

(72) Inventor: Felix Wiewel, Muenchingen (DE)

(21) Appl. No.: 19/169,045

(22) Filed: Apr. 3, 2025

(30) Foreign Application Priority Data
May 10, 2024 (DE) 10 2024 204 360.5

(51) Int. Cl. G01S 7/40; G01S 7/41

(52) U.S. Cl. CPC G01S 7/4039; G01S 7/417

(57) ABSTRACT

A method for ascertaining a function-impairing, environment-related occlusion of a radar sensor. The method includes: providing measurements, assigned from a measuring step, of spectra in each case calculated by transmitting a sensor signal from the radar sensor and receiving reflections of the sensor signal from environmental objects in an environment of the radar sensor, the calculated spectra including at least a first and a second spectrum. The second spectrum is based on at least one measurement which includes a focused directional characteristic due to beam shaping compared to at least one measurement underlying the first spectrum. An occlusion degree of the occlusion is calculated by a trained neural network according to multidimensional input data based on the spectra including the first and second spectrum. An occlusion ascertainment device is also described.

### CROSS REFERENCE

The present application claims the benefit under 35 U.S.C. § 119 of Germany Patent Application No. DE 10 2024 204 360.5 filed on May 10, 2024, which is expressly incorporated herein by reference in its entirety.

### FIELD

The present invention relates to a method for ascertaining an occlusion of a radar sensor. The present invention furthermore relates to an occlusion ascertainment device.

### BACKGROUND INFORMATION

Germany Patent Application No. DE 10 2021 202 299 A1 describes a method for recognizing sensor blindness in a radar sensor. The radar sensor sends out a radar sensor signal and receives the reflected radar sensor signal. A radar spectrum is ascertained on the basis of the received reflected radar sensor signal. At least part of the ascertained radar spectrum is provided as an input value to a convolutional neural network. An output value with respect to the sensor blindness of the radar sensor is calculated and output by the neural network.

### SUMMARY

According to the present invention, a method for ascertaining an occlusion of a radar device is provided. According to an example embodiment of the present invention, the method includes: providing measurements, assigned from a measuring step, of spectra in each case calculated by transmitting a sensor signal from the radar sensor and receiving reflections of the sensor signal from environmental objects in an environment of the radar sensor, the calculated spectra including at least a first and a second spectrum, wherein the second spectrum is based on at least one measurement of the measuring step, which includes a focused directional characteristic due to beam shaping compared to at least one measurement of the measuring step underlying the first spectrum, and calculating an occlusion degree of the occlusion by a trained neural network according to multidimensional input data based on the spectra including the first and second spectrum.

As a result of the method, ascertaining the occlusion can be carried out more cost-effectively, quickly and reliably. The computing and storage capacities required for carrying out the method of the present invention can be smaller. The spectra already provided for the environmental detection of the environment of the radar sensor can be used additionally for ascertaining the occlusion.

The radar sensor can be a MIMO radar sensor. The radar sensor can comprise a plurality of transmitting antennas, for example four transmitting antennas, and a plurality of receiving antennas, for example four receiving antennas. The radar sensor can be multi-channel, for example it can comprise 12 channels for detecting environmental objects. The sensor signal can be output by the transmitting antennas and the reflections can be received by the receiving antennas.

The radar sensor can be arranged in a device, in particular a mobile device, for example a vehicle. The vehicle can be a motor-driven vehicle, for example a motor vehicle or a two-wheeled vehicle, in particular a motorcycle. The radar sensor can be arranged for the environmental detection of the environment of the device. The environmental detection can comprise object recognition of the environmental objects in the environment and/or object classification of the environmental objects in the environment.

The environmental objects can comprise living beings, such as persons, plants, buildings, stationary facilities, such as infrastructure facilities and/or mobile facilities, such as vehicles.

The occlusion can be caused by the accumulation and/or deposition of substances, for example dirt, dust, mud, snow and/or ice on the radar sensor. The occlusion can cause sensor blindness of the radar sensor. The occlusion can be caused by heavy precipitation on and/or in the field of view of the radar sensor.

According to an example embodiment of the present invention, the first and/or second spectrum can be calculated at least indirectly from the received time signal of the radar sensor. The first and/or second spectrum can be a frequency spectrum. The first and/or second spectrum can be calculated at least indirectly by (fast) Fourier transformation. The first and/or second spectrum can be a spectrum already provided for the environmental detection of the environment of the radar sensor.

The first and second spectrum can in each case be calculated according to a plurality of output spectra. In a multi-channel radar sensor, the first spectrum can be calculated by non-coherent integration of the output spectra and/or the second spectrum by coherent integration of the output spectra. Non-coherent integration can omit phase information from the multi-channel sensor signal. Coherent integration can include phase information of the multi-channel sensor signal. Non-coherent or coherent integration can include averaging. The output spectra can be calculated by (fast) Fourier transformation from temporal sensor signals of the radar sensor. The output spectra can be present in raw form. For example, the dimensions of distance and Doppler velocity can be present in raw form, i.e. before being assigned to absolute distance values and Doppler velocity values.

According to an example embodiment of the present invention, in addition to the first and second spectrum, the spectra can comprise at least one further spectrum. The further spectrum can also comprise a focused directional characteristic compared to at least one measurement of the measuring step underlying the first spectrum, due to beam shaping. The directional characteristic can be an azimuth angle range that differs from the directional characteristic of the second spectrum. The spectra can comprise a plurality of spectra, in particular three spectra including the second spectrum, that exhibit a focused directional characteristic due to beam shaping, compared to at least one measurement underlying the first spectrum in the measuring step.

Beam shaping can be digital beam forming (DBF).

According to an example embodiment of the present invention, the measuring step can be a temporally connected and limited measuring process of the radar sensor. During the measuring step, a plurality of simultaneous or sequential measurements can be carried out using the radar sensor. Preferably, the measurements of a measuring step relate to the same environmental scene of the environment or at least to environmental scenes of the environment that are directly temporally related.

The input data can comprise at least the first and second spectrum. The input data can be formed by aggregating the first and second spectrum. The input data can be calculated from the first and second spectrum by preprocessing. Preprocessing can apply machine learning, in particular a further trained neural network. Preprocessing can calculate an overall spectrum from the first and second spectrum. The total spectrum can comprise the original dimensions of the first and/or second spectrum. The total spectrum can be specified in a latent space. The input data can correspond to the entire spectrum.

In addition to the spectra, the input data can contain additional features, which are obtained, for example, by an optional feature extraction module. The additional features can be combined with the spectra before applying the neural network. These additional features can be, for example, temperature data or other sensor measurements. Instead of combining the additional features before applying the neural network, the additional features can also be processed in a separate region of the neural network and the results can be merged in one of the last layers, in particular the last layer, of the neural network.

In a preferred design of the present invention, it is advantageous if the at least one measurement of the radar sensor underlying the first spectrum is carried out over the entire field of view of the radar sensor and the at least one measurement of the radar sensor underlying the second spectrum is carried out over a limited sub-region of the entire field of view of the radar sensor. The sub-region can be an angle range delimited by a limited azimuth angle and/or elevation angle. The first measurement of the radar sensor underlying the first spectrum can also have been carried out over at least a larger field of view than the at least one measurement on which the wide spectrum is based.

In an advantageous design of the present invention, the first spectrum and/or second spectrum comprises at least the dimensions of distance and Doppler velocity. The distance relates to a separation between the radar sensor and the respective environmental objects. The Doppler velocity indicates the relative velocity of the respective environmental objects to the radar sensor.

The first and/or second dimension can be different from a dimension indicating an azimuth angle range of the field of view of the radar sensor and/or a dimension indicating an elevation angle range of the field of view of the radar sensor.

The first and second spectrum can comprise the same dimensions as one another.

In a preferred design of the present invention, the input data comprise at least the dimensions of the first and second spectrum as dimensions. The input data can comprise at least one additional dimension compared to the first and second spectrum.

In a preferred design of the present invention, it is advantageous if one dimension of the input data is formed by the number of spectra of the input data including the first and second spectrum. The number of values in this dimension can be equal to the number of spectra. This dimension can be the further dimension of the input data.

In a special design of the present invention, it is advantageous if the occlusion degree is calculated according to a plurality of occlusion classes. The occlusion classes can indicate the degree of contamination and/or degree of impairment on the detection performance of the radar sensor. One occlusion class can be “no contamination” or “functional” and a further occlusion class can be “complete occlusion” or “non-functional.” At least one occlusion class can lie between these two degrees.

The classification can be binary, i.e. limited to two occlusion classes.

A preferred configuration of the present invention is advantageous in which the occlusion degree is calculated according to class probabilities of the occlusion classes. A class probability can be calculated for each occlusion class. The occlusion degree can be calculated according to the individual class probabilities. The occlusion degree can correspond to the occlusion class having the highest probability.

The class probability indicates in particular the probability of the relevance of the particular occlusion class to the input data.

A preferred configuration of the present invention is advantageous in which a plurality of occlusion degrees are calculated over a plurality of measuring steps and subsequently a final occlusion degree is calculated from the plurality of occlusion degrees by means of an averaging filter. The averaging filter can be an exponential moving average (EMA) filter. The EMA is a filter that gives greater weight to recent occlusion degrees in order to smooth out trends. The averaging filter can apply a moving average that weights all data equally.

The final occlusion degree can be output as the output occlusion degree.

According to an example embodiment of the present invention, the calculation of the output occlusion degree can be carried out by a decision rule with hysteresis. Hysteresis can ensure that small, possibly random, variations in the final occlusion degrees do not immediately lead to a change in the output occlusion degree, but that a significant and sustained change is required. As a result, excessively frequent changes in the output occlusion degree can be avoided. As a result, small, potentially random variations in the final occlusion degrees do not immediately cause a sudden change in the output occlusion degree.

In a special configuration of the present invention, it is advantageous if the neural network is a convolutional neural network (CNN). The CNN uses convolutional layers, in particular two-dimensional convolutional layers, having convolutions for filtering and extracting features from the input data, in particular to recognize structures and patterns in the input data. The CNN comprises at least one convolutional layer, one pooling layer and/or one dense output layer. The pooling layer can be a mean pooling layer or a max pooling layer. The pooling layer can apply global pooling. The convolutional layer can serve for feature extraction, the pooling layer for reducing the spatial size of the features and the dense output layer for classification. If storage requirements are particularly high, the CNN can manage only with one convolutional layer and one pooling layer, which makes storing the convolutional features unnecessary.

In order to increase computational efficiency, strided convolutions can be used, which reduce the feature map by subsampling. In strided convolutions, not all points of the input data are used; rather, steps are made over some points of the input data.

The method for ascertaining can be a computer-implemented method. The method for ascertaining can be carried out in the device.

Furthermore, a computer program that comprises machine-readable instructions executable on at least one computer, upon execution of which the method of the present invention for ascertaining runs, is proposed.

Furthermore, a storage unit is proposed, which is designed to be machine-readable and accessible by at least one computer and on which the aforementioned computer program is stored. The storage unit can be arranged in the device.

According to the present invention, an occlusion ascertainment device having certain features of the present invention is also provided. The occlusion ascertainment device can be arranged in the device, in particular the mobile device, such as the vehicle. The occlusion ascertainment device can be arranged together with the radar sensor in and/or on the device.

Further advantages and advantageous configurations of the present invention can be found in the description of the figure and in the figure.

### BRIEF DESCRIPTION OF THE DRAWING

FIG. 1 shows a method for ascertaining and an occlusion ascertainment device, according to an example embodiment of the present invention

### DETAILED DESCRIPTION OF EXAMPLE EMBODIMENTS

The present invention is described in detail below with reference to the figure.

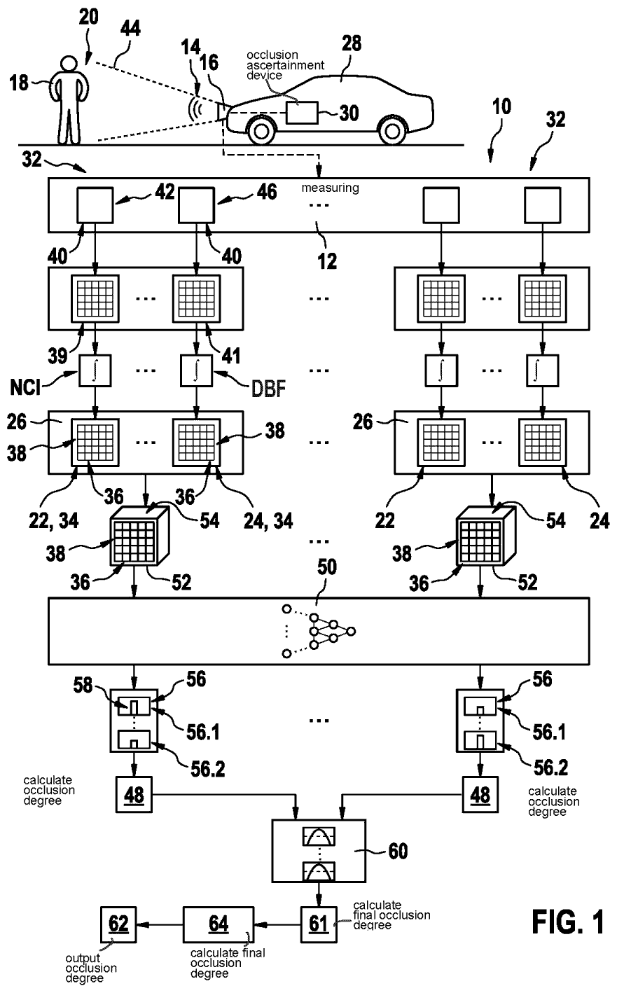

FIG. 1 shows a method for ascertaining and an occlusion ascertainment device, in each case in a specific embodiment of the present invention. The method for ascertaining 10 a function-impairing occlusion of a preferably multi-channel radar sensor initially comprises providing spectra 26 calculated from measurements 12 in each case by transmitting a sensor signal 14 of the radar sensor 16 and receiving reflections of the sensor signal 14 from environmental objects 18 in an environment 20 of the radar sensor 16, the spectra including at least a first spectrum 22 and a second spectrum 24. The radar sensor 16 can be arranged on a vehicle 28 for environmental detection of the environment 20. The method for ascertaining 10 the occlusion can be carried out in particular by an occlusion ascertainment device 30 in the vehicle 28.

The measurements 12 are assigned to a measuring step 32 of the radar sensor 16. The first and second spectrum 22, 24 is preferably in each case a frequency spectrum 34, in particular a distance-Doppler spectrum. Preferably, the first and second spectra 22, 24 are two-dimensional having the distance as the first dimension 36 and the Doppler velocity as the second dimension 38. In the multi-channel radar sensor 16, the first spectrum 22 can be calculated by non-coherent integration NCI of first output spectra 39, which are calculated from multi-channel time signals 40 of the radar sensor 16, for example by fast Fourier transformation, and the second spectrum 24 can be calculated by coherent integration DBF of second output spectra 41, which are calculated from multi-channel time signals 40 of the radar sensor 16, for example by fast Fourier transformation.

The second spectrum 24 is based on measurements 46 that, due to beam shaping, comprise a focused directional characteristic compared to the measurements 42 on which the first spectrum 22 is based. The measurement 42 of the radar sensor 16 underlying the first spectrum 22 is carried out over the entire field of view 44 of the radar sensor 16, and the measurement 46 of the radar sensor 16 underlying the second spectrum 24 is carried out over a limited sub-region of the entire field of view 44 of the radar sensor 16.

Subsequently, for the measuring steps 32, in each case a calculation of an occlusion degree 48 of the occlusion is performed by a trained neural network 50, in particular a convolutional neural network (CNN), according to multidimensional input data 52, which are based on the spectra 26, including the first and second spectrum 22, 24. The first spectra 22 of the plurality of measuring steps 32 can of course comprise values that differ from one another. The same applies to the second spectra 26. The input data 52 are formed, for example, by aggregating the spectra 26 and comprise at least the dimensions of the first and second spectrum 22, 24 as dimensions, that is to say here in particular the distance as the first dimension 36 and the Doppler velocity as the second dimension 38. A third dimension 54 of the input data 52 is formed by the number of spectra 26 of the input data 52 including the first and second spectrum 22, 24.

The occlusion degree 48 calculated by the neural network 50 with the input data 52 is preferably calculated according to a plurality of occlusion classes 56, for example an occlusion class 56.1 (“no contamination”) and a further occlusion class 56.2 (“complete occlusion”), by calculating class probabilities 58 of the occlusion classes 56 and calculating the occlusion degree 48 as corresponding to the occlusion class 56 with the highest probability. The class probability 58 indicates in particular the probability of the relevance of the particular occlusion class 56 to the input data 52. For example, the occlusion classes 56 are specified and the neural network 50 calculates the class probability 58 for each of the occlusion classes 56.

A plurality of occlusion degrees 48 are calculated over a plurality of measuring steps 32, and subsequently a final occlusion degree 61 is calculated from the plurality of occlusion degrees 48 by an averaging filter 60. The averaging filter 60 can be an exponential moving average (EMA) filter. The calculation of the output occlusion degree 62 from the final occlusion degree 61 is carried out by a decision rule 64 with hysteresis. As a result, small, possibly random variations in the final occlusion degrees 61 do not immediately cause a sudden change in the output occlusion degree 62.

What is claimed is:

1. A method for ascertaining a function-impairing, environment-related occlusion of a radar sensor, the method comprising the following steps:
providing measurements, assigned from a measuring step, of spectra in each case calculated by transmitting a sensor signal from the radar sensor and receiving reflections of the sensor signal from environmental objects in an environment of the radar sensor, the calculated spectra including at least a first and a second spectrum, wherein the second spectrum is based on at least one measurement of the measuring ste, which includes a focused directional characteristic due to beam shaping compared to at least one measurement of the measuring step underlying the first spectrum; and
calculating an occlusion degree of the occlusion by a trained neural network according to multidimensional input data based on the spectra including the first and second spectrum.

2. The method for ascertaining according to claim 1, wherein the at least one measurement of the radar sensor underlying the first spectrum is carried out over an entire field of view of the radar sensor, and the at least one measurement of the radar sensor underlying the second spectrum is carried out over a limited sub-region of the entire field of view of the radar sensor.

3. The method for ascertaining according to claim 1, wherein the first spectrum and/or second spectrum include at least dimensions of distance and Doppler velocity.

4. The method for ascertaining according to claim 1, wherein the multidimentional input data include at least the dimensions of the first and second spectrum as dimensions of the multidimensional input data.

5. The method for ascertaining according to claim 1, wherein a dimension of the input data is formed by a number of spectra of the input data including the first and second spectrum.

6. The method for ascertaining according to claim 1, wherein the occlusion degree is calculated according to a plurality of occlusion classes.

7. The method for ascertaining according to claim 6, wherein the occlusion degree is calculated according to class probabilities of the occlusion classes.

8. The method for ascertaining according to claim 1, wherein a plurality of occlusion degrees are calculated over a plurality of measuring steps and subsequently a final occlusion degree is calculated from the plurality of occlusion degrees using an averaging filter.

9. The method for ascertaining according to claim 1, wherein the neural network is a convolutional neural network.

10. An occlusion ascertainment device configured to ascertain a function-impairing, environment-related occlusion of a radar sensor. the occlusion ascertain device comprising a computer and is configured to:
provide measurements, assigned from a measuring step, of spectra in each case calculated by transmitting a sensor signal from the radar sensor and receiving reflections of the sensor signal from environmental objects in an environment of the radar sensor, the calculated spectra including at least a first and a second spectrum, wherein the second spectrum is based on at least one measurement of the measuring ste, which includes a focused directional characteristic due to beam shaping compared to at least one measurement of the measuring step underlying the first spectrum; and
calculate an occlusion degree of the occlusion by a trained neural network according to multidimensional input data based on the spectra including the first and second spectrum.
